(19) United States
(12) Patent Application Publication
(10) Pub. No.: US 2012/0147620 A1
(43) Pub. Date: Jun. 14, 2012

(54) WARNING LAMP STRUCTURE

(75) Inventor: TZU-FAN KUO, TAINAN (TW)

(73) Assignee: LUMINOUS STAR TECHNOLOGY LTD., TAINAN (TW)

(21) Appl. No.: 12/965,144

(22) Filed: Dec. 10, 2010

(51) Int. Cl. B60Q 1/26

(52) U.S. Cl. 362/542

(57) ABSTRACT

This invention relates to a warning lamp structure in which a light emitting module and a lamp hood are arranged in order on a base plate. The lamp hood is molded to have a hollow chamber so as to cover the light emitting module. A light concentrating section is integrally formed on the wall surface of the hollow chamber of the lamp hood. Configured in this manner, the bulk volume of the warning lamp is significantly reduced by the integral molding design of the light concentrating section on the lamp hood, so that the warning lamp can be advantageously assembled together with member of various types or member subjected to space limitation so as to reach substantial effect of increasing competitiveness on market.

### BACKGROUND OF THE INVENTION

1. Field of the Invention

The present invention relates to a warning lamp structure, more particularly to a warning lamp structure having a light concentrating section integrally formed on the lamp hood so as to reduce significantly the bulk volume of the warning lamp, so that the warning lamp can be advantageously assembled together with members subjected to space limitation.

2. Brief Description of the Prior Art

Warning lamp mainly applies sound or light effect to attract visual attention of people so as to attain the effect of warning or instruction. For example, the warning lamps set in the ambulances, police cars, fire trucks and construction vehicles, etc. can provide alert for opposite or rear vehicles, the surrounding cars and the people, in order that they can keep proper distance with the vehicle having warning lamp so as to prevent collisions and other accidents.

Conventional warning lamp usually has a light emitting module, light concentrating elements and a lamp hood assembled in order on a base plate. When light is emitted from light emitting bodies of the light emitting module, light is converged by the light concentrating elements to raise the brightness level thereof so as to provide alert effect for people and cars around.

However, as the light concentrating elements and the lamp hood in the conventional warning lamp are separately provided, the assembly work thereof becomes more complicated. In order that the light concentrating elements and the lamp hood separately provided can be assembled together easily, usually bigger accommodation space is preserved in the lamp hood in such a manner that the light concentrating element fails to be mounted in the interior of the lamp hood due to insufficient fitting allowance between the lamp hood and the light concentrating elements will not happen. In addition, bigger accommodation space provided in each lamp hood can facilitate mounting of the light concentrating element within the lamp hood. Thus, not only material cost is increased but also the warning lamp is bulky in the whole volume thereof. The oversized warning lamp is difficult to be assembled on any member subjected to space limitation; hence application range thereof is constricted. If this warning lamp is forced to be assembled with the member subjected to space limitation, the overall look is also affected. All these factors are apt to cause difficulties in assembly and implementation of the warning lamp.

In view of the above disadvantages, the inventor of the present invention provides a novel warning lamp according to the state-of-art research and improvement conducted on the conventional structure, based on his abundant experience of R&D and manufacturing in relevant field and skillful contemplation in many ways.

### SUMMARY OF THE INVENTION

This invention relates to a warning lamp structure the main object of which is to provide a warning lamp enabling effective reduction on the bulk volume thereof so as to facilitate the combination of the warning lamp with member of various types or member subjected to space limitation.

In order to achieve above object, the inventor of this invention provides an warning lamp structure in which a light emitting module and a lamp hood are arranged in order on a base plate, the lamp hood being molded to have a hollow chamber so as to cover the light emitting module; a light concentrating section being integrally formed on the wall surface of the hollow chamber of the lamp hood and being arranged to be opposite to the light emitting bodies of the light emitting module.

In this manner, the bulk volume of the warning lamp can be significantly reduced, so that the warning lamp can be advantageously and properly assembled with member of various types or member subjected to space limitation, so as to achieve substantial effect of enhancing competitiveness on market. Furthermore, as the light concentrating section is integrally formed on the lamp hood, die expense of light concentrating element and material cost can be saved so as to significantly lower down the total manufacturing cost of the warning lamp. Additionally, as the process of assembling light concentrating element is omitted, labor hour and hence the efficiency of assembly can be further improved.

Moreover, the present invention is further provided with a plurality of light receiving protruding ridges so as to form a light receiving surface. Configuring like this, when the light emitted from the light emitting bodies is refracted by the light concentrating sections, part of light dispersed due to refraction through the light concentrating section is further guided and concentrated by the light receiving protruding ridges of the light receiving surface so as to project in a direction perpendicular to the light receiving surface. In this manner, not only the structure is conformed to the requirement of law regulations but also the light, which is concentrated to project out, is contributive to further raise the brightness level of the warning lamp.

Furthermore, this invention is further provided with a plurality of protruding ridges on the inner side wall surface of the lamp hood such that the light emitted from the light emitting bodies is converged thereby, when passing through the protruding ridges. In this manner, the illumination and the projecting range of the light emitted by the light emitting bodies can be increased.

### BRIEF DESCRIPTION OF ACCOMPANYING DRAWINGS

FIG. 1 is a perspective exploded view showing the warning lamp structure of the present invention.

FIG. 2 is a perspective assembled view showing the warning lamp structure of the present invention.

FIG. 3 is an assembled sectional front view showing the warning lamp structure of the present invention.

FIG. 4 is an assembled sectional side view showing the warning lamp structure of the present invention.

FIG. 5 is a perspective exploded view showing another embodiment of the warning lamp structure of the present invention.

FIG. 6 is a perspective assembled view showing another embodiment of the warning lamp structure of the present invention.

FIG. 7 is an assembled sectional front view showing another embodiment of the warning lamp structure of the present invention.

FIG. 8 is a prospective view showing still another embodiment of the warning lamp structure of the present invention.

FIG. 9 is a sectional view showing still another embodiment of the warning lamp structure of the present invention.

### DETAILED DESCRIPTION OF PREFERRED EMBODIMENT

The objects, the technical contents and the expected effectiveness of the present invention will become more apparent from the detailed description of the preferred embodiment in conjunction with the accompanying drawings.

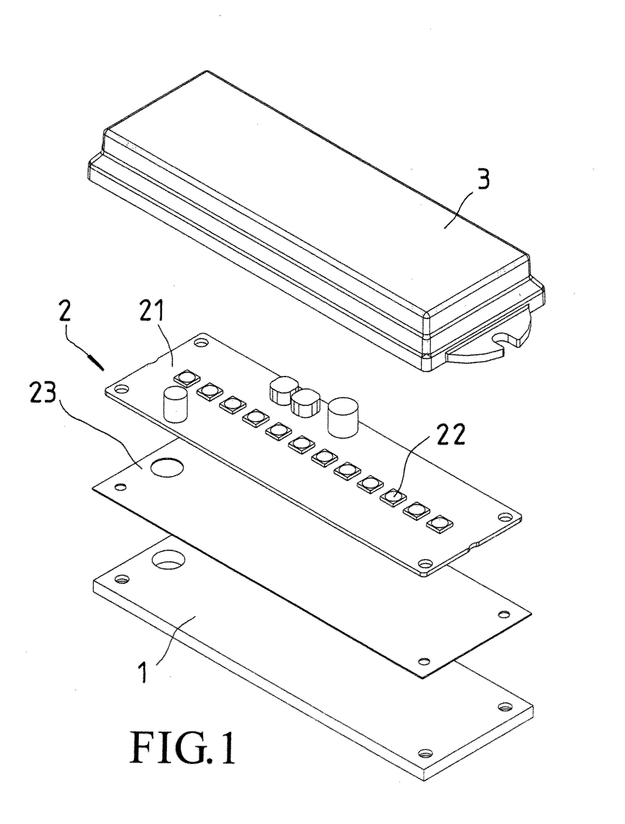

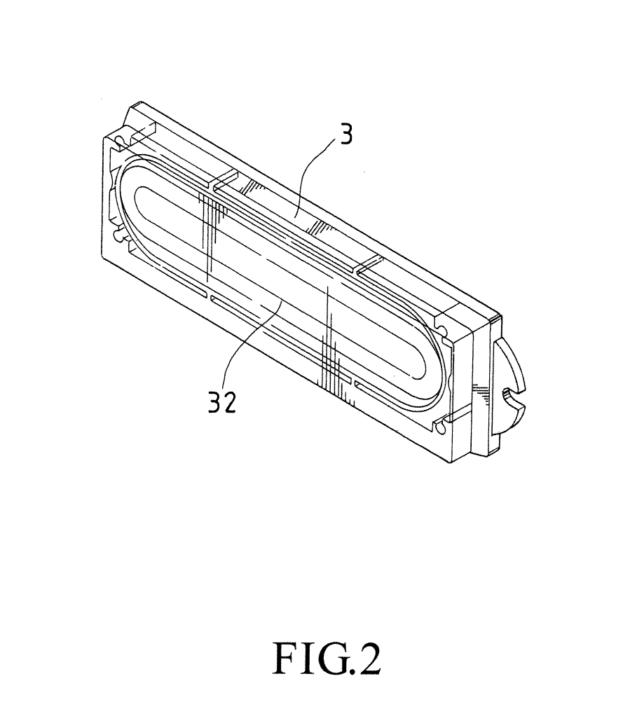

Firstly referring to FIGS. 1 and 2, the warning lamp structure of the present invention has a light emitting module (2) and a lamp hood (3) assembled in this order on a base plate (1). [The base plate (1) is a heat sink].

The light emitting module (2) essentially has a plurality of light emitting body (22) assembled on a circuit board (21). The light emitting bodies (22) are light emitting diodes of surface mount device (SMD) type. An insulating sheet (23) is provided between the circuit board (21) and the base plate (1).

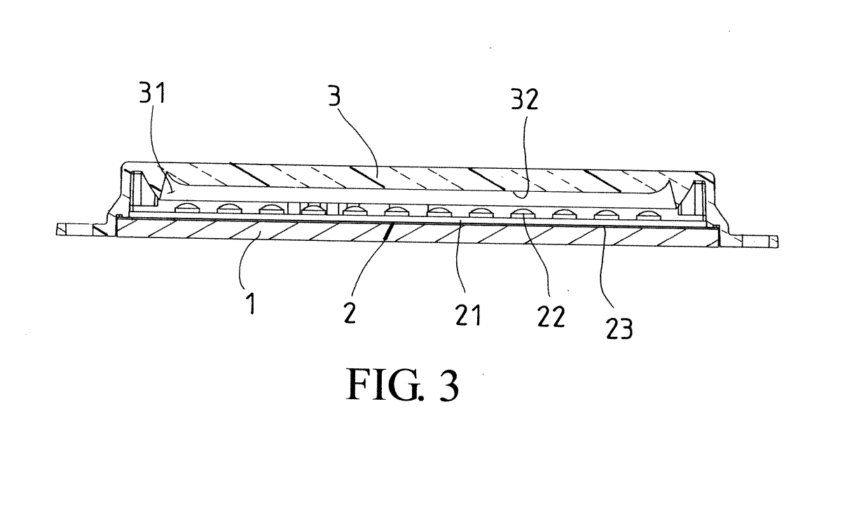

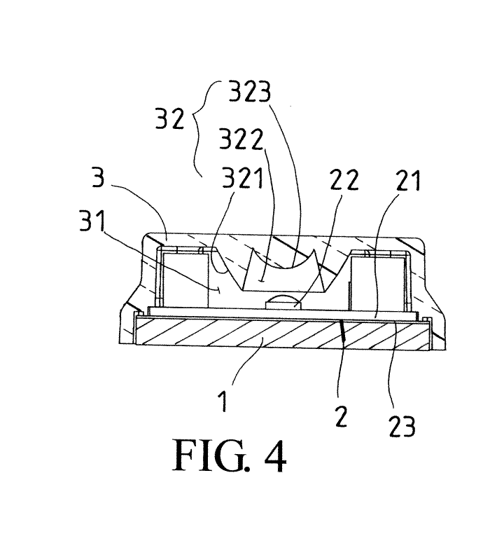

Referring to FIGS. 3 and 4, the lamp hood (3) is formed with a hollow chamber (31) and a light concentrating section (32) is integrally formed on the wall surface of the hollow chamber (31) of the lamp hood (3). The light concentrating section (32) essentially includes a light concentrating section body (321) formed as a curved projection shape, a light guiding groove (322) in frustum shape being provided in the bottom center of the light concentrating section body (321), and a convex lens (323) being formed on the end portion of the light guiding groove (322).

Configuring like this, when assembly is undertaken as shown in FIGS. 3 and 4, the light emitting module (2) is assembled on the base plate (1), then the lamp hood (3) is covered over the light emitting module (2) and fixed on the base plate (1) in such a manner that the light emitting module (2) is accommodated in the hollow chamber (31) of the lamp hood (3), and that the light emitting bodies (22) of the light emitting module (2) is located to be opposite to the light guiding groove (322) of the light concentrating section (32).

Thus, when power is ON so as to ignite the light emitting bodies (22), the light emitted from the light emitting bodies (22) is projected out after refraction and spotlight through the light concentrating section body (321) and the light guiding type optical convex lens (323) provided in the light guiding groove (322) so as to reach light-concentration effect by illuminating light having very high brightness. In this manner, car drivers and pedestrians on the road can clearly see the light emitted from the warning lamp afar and achieve good warning effect.

As the warning lamp of the present invention has a light concentrating section (32) integrally formed on the lamp hood (3), there is no need to use additionally prepared die for producing light concentrating element. Hence, both die expense and material cost can be saved. What is more, as there is no need to separately assemble the light concentrating element, labor hour of assembly can be reduced. Since the light concentrating section (32) of the present invention is formed integrally with the lamp hood (3) during production, there is no need to produce lamp hood (3) having bigger volume and reserving additional accommodating space for combining with the light concentrating section element like conventional design. Therefore, not only material cost can be saved but also the bulk volume of the warning lamp can be reduced, so that the warning lamp can be advantageously assembled together with member of various types or member subjected to space limitation.

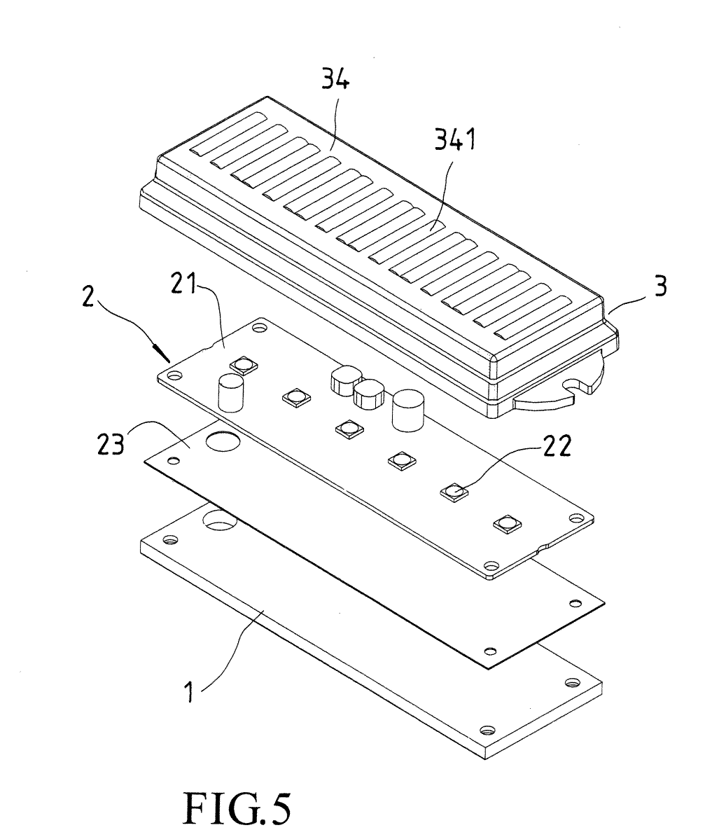

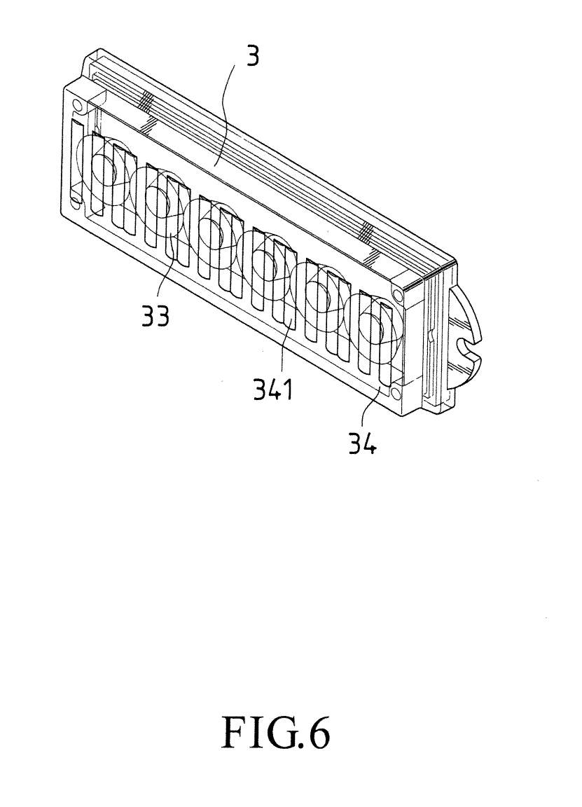

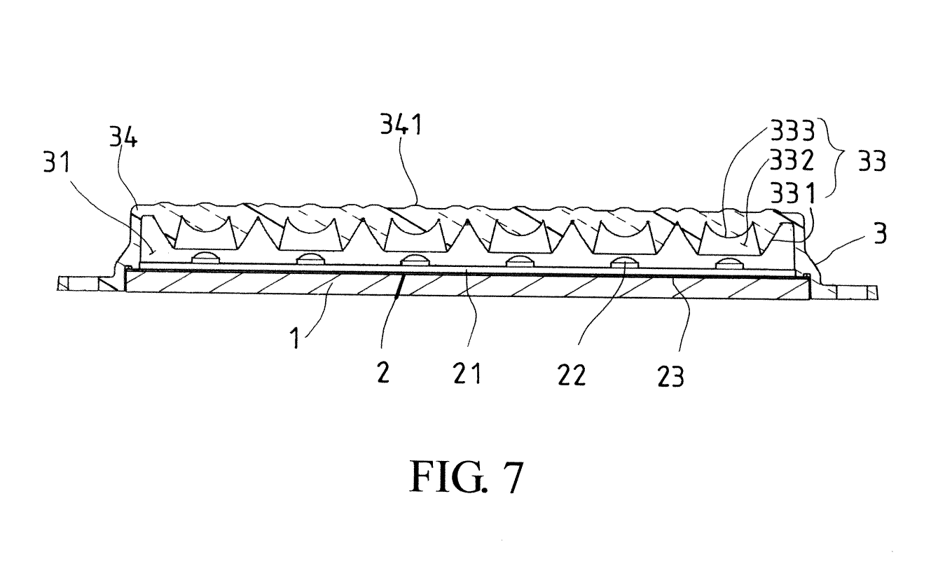

Further referring to another embodiment of the warning lamp of the present invention as shown in FIGS. 5 to 7, the light concentrating section (33) integrally formed on the wall surface of the hollow chamber (31) of the lamp hood (3) has a plurality of semi-circular shape light concentrating section body (331). Each light concentrating section body (331) has a light guiding groove (332) in frustum shape provided in the bottom center thereof, and a convex lens (333) is formed on the end of the light guiding groove (332). Configuring like this, after light is emitted from the light emitting bodies (22) opposite to the light guiding grooves (332) of the light concentrating section (33), the light is refracted many times in the semi-circular shape light concentrating section (33) and then is spotlighted to project out. In this manner, the illumination of the light emitted from the light emitting bodies (22) can be enhanced so as to provide alarm effectively to pedestrians and car drivers around.

Moreover, the present invention is further provided with a plurality of light receiving protruding ridge (341) on the surface of the lamp hood (3) so as to form a light receiving surface (34). Part of the light emitted from the light emitting bodies (22) dispersed due to refraction by the light concentrating sections (33) can be further guided and concentrated by the light receiving protruding ridges (341) of the light receiving surface (34), so as to project in a direction perpendicular to the light receiving surface (34). In this manner, not only the structure is conformed to the requirement of law regulations but also the light is further concentrated, so as to contribute to raise the brightness level of the light projected out. Therefore, car drivers and pedestrians can clearly see the light emitted from the warning lamp afar and achieve better warning effect.

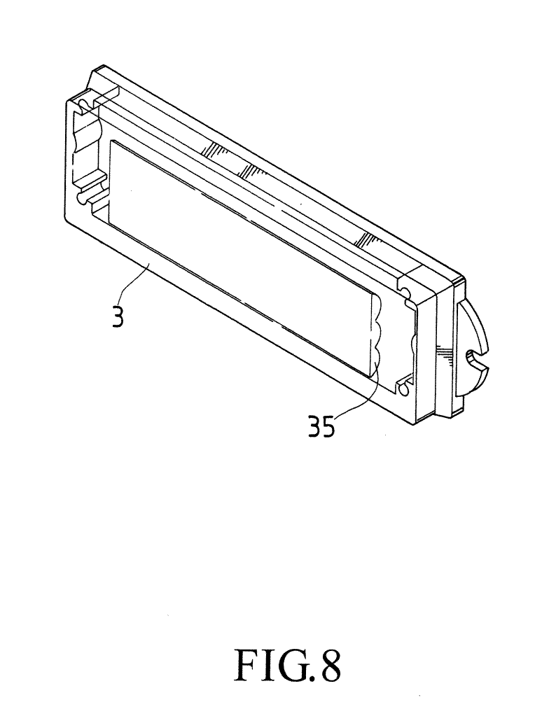

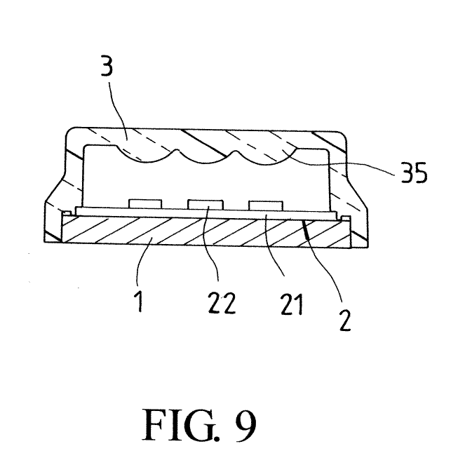

Further as shown in FIGS. 8 and 9 of still another embodiment of the warning lamp of this invention, a plurality of protruding ridge (35) is provided on the inner side wall surface of the lamp hood (3) such that the light emitted from the light emitting bodies (22) is spotlighted thereby, when passing through the protruding ridges (35) having the same function as convex lens. In this manner, illumination level of the light emitting diodes (2) and the projecting range of the light can be increased.

Based on the abovementioned structure and its implementation mode, the warning lamp structure of the present invention has the following advantages.

1. In the present invention, the light concentrating section and the lamp hood of the warning lamp is integrally formed so that the bulk volume of the lamp hood can be saved so as to remarkably reduce the bulk volume of the warning lamp. The warning lamp thus downsized can be advantageously assembled together with member of various types or member subjected to space limitation so as to reach substantial effect of increasing competitiveness on market.

2. In the present invention, the light concentrating section and the lamp hood of the warning lamp is integrally formed so that the die expense of light concentrating element and material cost containing unnecessary scrap can be saved so as to significantly lower down the total manufacturing cost of the warning lamp.

3. As the light concentrating section and the lamp hood of the warning lamp is integrally formed in the present invention, the process and thus the labor hour of assembling the light concentrating section is omitted, hence the efficiency of assembly can be further improved.

4. In addition to the integral formation of the light concentrating section on the lamp hood in the present invention, a plurality of light receiving protruding edge is provided on the surface of the lamp hood to form a light receiving surface. With this configuration, part of the light emitted from the light emitting bodies dispersed due to refraction by the light concentrating sections can be further guided and concentrated by the light receiving protruding ridges of the light receiving surface, so as to project in a direction perpendicular to the light receiving surface. In this manner, not only the structure is conformed to the law regulations but also the light is further concentrated, so as to contribute to raise the brightness level of the lamp.

5. In the present invention, a plurality of protruding ridge is provided on the inner side wall surface of the lamp hood such that the light emitted from the light emitting bodies is spotlighted thereby, when passing through the protruding ridges. In this manner, the illumination level of the light emitting diodes and the projecting range of the light can be increased.

6. In the present invention, the light emitting bodies adopted are light emitting diodes of surface mount device (SMD) type. In this manner, the bulk volume of the warning lamp can be further reduced.

What is claimed is:

1. An warning lamp structure, having a light emitting module (2) and a lamp hood (3) arranged in this order on a base plate (1), wherein:
said lamp hood (3) being molded to have a hollow chamber (31) so as to cover said light emitting module (2), a light concentrating section (32), (33) being integrally formed on the wall surface of said hollow chamber (31) of said lamp hood (3) and being arranged to be opposite to the light emitting bodies (22) of said light emitting module (2).

2. An warning lamp structure as claimed in claim 1, wherein said light concentrating section (32) of said lamp hood (3) is formed with a light concentrating section body (321) having a curved projection shape, a light guiding groove (322) being provided in the bottom center of said light concentrating section body (321), and a convex lens (323) being formed on the end portion of said light guiding groove (322).

3. A warning lamp structure as claimed in claim 2, wherein a plurality of light receiving protruding ridge (341) is further provided on the surface of said lamp hood (3).

4. A warning lamp structure as claimed in claim 2, wherein said light guiding groove (322) of said lamp hood (3) is formed as frustum shape.

5. An warning lamp structure as claimed in claim 1, wherein said light concentrating section (33) of said lamp hood (3) has a plurality of semi-circular shape light concentrating section body (331), each said light concentrating section body (331) having a light guiding groove (332) provided in the bottom center thereof, and a convex lens (333) being formed on the end portion of said light guiding groove (332).

6. A warning lamp structure as claimed in claim 5, wherein a plurality of light receiving protruding ridge (341) is further provided on the surface of said lamp hood (3).

7. A warning lamp structure as claimed in claim 5, wherein said light guiding groove (322) of said lamp hood (3) is formed as frustum shape.

8. A warning lamp structure as claimed in claim 1, wherein a plurality of protruding ridge (35) is further provided on the inner side wall surface of said lamp hood (3).

9. A warning lamp structure as claimed in claim 1, wherein said light emitting bodies (22) of said light emitting module (2) are light emitting diodes (22) of surface mount device (SMD) type.
